(19) United States
(12) Patent Application Publication
(10) Pub. No.: US 2022/0036383 A1
(43) Pub. Date: Feb. 3, 2022

(54) PURCHASE SUPPORT SERVER, PURCHASE SUPPORT METHOD, PURCHASE SUPPORT SYSTEM, AND PROGRAM

(71) Applicant: The Pokemon Company, Tokyo (JP)

(72) Inventors: Kaname KOSUGI, Tokyo (JP); Marie SHUTO, Tokyo (JP)

(73) Assignee: The Pokemon Company, Tokyo (JP)

(21) Appl. No.: 17/501,160

(22) Filed: Oct. 14, 2021

Related U.S. Application Data
(63) Continuation of application No. PCT/JP2020/010154, filed on Mar. 10, 2020.

(30) Foreign Application Priority Data
Apr. 17, 2019 (JP) 2019-078930

(51) Int. Cl. G06Q 30/02; G06Q 30/06

(52) U.S. Cl. CPC G06Q 30/0201; G06Q 30/0621; G06Q 30/0217

(57) ABSTRACT

A purchase support server including circuitry configured to store attribute information of each user and made-to-order contents of clothing; specify another user associated with an attribute of a user to purchase made-to-order clothing based on the attribute information of each user and which outputs, to a terminal of the user to purchase made-to-order clothing, information on made-to-order contents of the other user as a custom-making target of the clothing; and accept a custom-making operation with respect to the output made-to-order contents from the terminal and which executes order processing using a made-to-order result obtained by reflecting the custom-making operation onto the made-to-order contents.

### CROSS-REFERENCE TO RELATED APPLICATIONS

This is a Bypass Continuation of National Stage Application based on PCT/JP2020/010154, filed Mar. 10, 2020, which claims priority to JP 2019-078930, filed Apr. 17, 2019, the entire contents of each are incorporated herein by its reference.

### TECHNICAL FIELD

The present disclosure relates to a purchase support server, a purchase support method, a purchase support system, and a program.

### BACKGROUND

There are made-to-order services that accept custom-making of shirts and the like online. On the other hand, such made-to-order services require a user to set a wide variety of items, which makes it difficult to design in a fashionable manner unless the user is reasonably knowledgeable and passionate about clothing or the like.

In consideration thereof, systems that assist such a custom-making operation by a user are known. For example, PTL 1 (Japanese Patent Application Publication No. 2018-170030) describes a system that presents designs by other users with similar taste as information for inspirational assistance when custom-making a design.

### PTL 1

Japanese Patent Application Publication No. 2018-170030

### SUMMARY

### Technical Problems

However, while the invention described in PTL 1 enables advice to be provided when custom-making, the user is no better off than using a conventional system in terms of having to personally consider and set made-to-order contents.

In other words, from the perspective of a general user who is not reasonably knowledgeable and passionate about clothing or the like, there is a problem in that a hurdle of utilizing a made-to-order service remains high.

In consideration thereof, the present disclosure has been made in order to solve the problems described above and an object thereof is to provide a system that makes a made-to-order service of clothing or the like readily utilizable regardless of knowledge and the like of a user.

### Solution to Problems

In one aspect, in order to achieve the object described above, a purchase support server according to the present disclosure includes: a storage unit which stores attribute information of each user and made-to-order contents of clothing; a target presenting unit which specifies another user associated with an attribute of a user to purchase made-to-order clothing based on the attribute information of each user in the storage unit and which outputs, to a terminal, information on made-to-order contents of the other user as a custom-making target of the clothing; and an order processing unit which accepts a custom-making operation with respect to the output made-to-order contents from the terminal and which executes order processing of the clothing using a made-to-order result obtained by reflecting the custom-making operation onto the made-to-order contents.

In addition, in order to achieve the object described above, a purchase support method according to the present disclosure includes the steps, by a server storing attribute information of each user and made-to-order contents of clothing in a storage unit, of: specifying another user associated with an attribute of a user to purchase made-to-order clothing based on the attribute information of each user in the storage unit and outputting, to a terminal, information on made-to-order contents of the other user as a custom-making target of the clothing; and accepting a custom-making operation with respect to the output made-to-order contents from the terminal and executing order processing of the clothing using a made-to-order result obtained by reflecting the custom-making operation onto the made-to-order contents.

Furthermore, in one aspect, in order to achieve the object described above, a purchase support system according to the present disclosure includes: a purchase support server including: a storage unit which stores attribute information of each user and made-to-order contents of clothing; a target presenting unit which specifies another user associated with an attribute of a user to purchase made-to-order clothing based on the attribute information of each user in the storage unit and which outputs, to a terminal of the user to purchase made-to-order clothing, information on made-to-order contents of the other user as a custom-making target of the clothing; and an order processing unit which accepts a custom-making operation with respect to the output made-to-order contents from the terminal and which executes order processing of the clothing using a made-to-order result obtained by reflecting the custom-making operation onto the made-to-order contents; and a terminal including: an output unit which transmits a made-to-order request including the attribute information of the user to the purchase support server and which acquires and displays information on the custom-making target; and a processing unit which accepts a custom-making operation by the user with respect to the displayed information on the custom-making target and which transmits contents of the custom-making operation as the made-to-order result to the purchase support server.

Moreover, in one aspect, in order to achieve the object described above, a program according to the present disclosure causes a server storing attribute information of each user and made-to-order contents of clothing in a storage unit to execute the steps of processing of: specifying another user associated with an attribute of a user to purchase made-to-order clothing based on the attribute information of each user in the storage unit and outputting, to a terminal of the user to purchase made-to-order clothing, information on made-to-order contents of the other user as a custom-making target of the clothing; and accepting a custom-making operation with respect to the output made-to-order contents from the terminal and executing order processing of the clothing using a made-to-order result obtained by reflecting the custom-making operation onto the made-to-order contents.

According to the present disclosure, a system that makes a made-to-order service of clothing or the like readily utilizable regardless of knowledge and the like of a user can be provided.

### BRIEF DESCRIPTION OF DRAWINGS

FIG. 1 is a diagram showing a configuration example of a purchase support system according to a present embodiment.

FIG. 2 is a diagram showing a configuration example of a purchase support server according to the present embodiment.

FIG. 3 is a diagram showing a configuration example of a terminal according to the present embodiment.

FIG. 4 is a flow chart showing an example of processing in the purchase support server according to the present embodiment.

FIG. 5 represents an example of a custom-making operation screen according to the present embodiment.

FIG. 6 is a diagram showing an example of an order history DB according to the present embodiment.

FIG. 7 represents an example of a made-to-order result screen according to the present embodiment.

FIG. 8 is a diagram showing an example of a replacement purchase management DB according to the present embodiment.

FIG. 9 represents an example of a replacement purchase recommendation notification screen according to the present embodiment.

FIG. 10 is a flow chart showing an example of processing in the purchase support server according to the present embodiment.

FIG. 11 is a diagram showing an example of an aggregate result DB according to the present embodiment.

FIG. 12 represents an example of a popularity ranking notification screen according to the present embodiment.

### DETAILED DESCRIPTION

Hereinafter, an embodiment of the present disclosure will be described with reference to the drawings. In all of the diagrams for explaining the embodiment, common components will be denoted by same reference signs and repetitive descriptions will be omitted. It is to be understood that the following embodiment does not unduly restrict the contents of the present disclosure as set forth in the scope of claims. In addition, not all components described in the embodiment are essential components of the present disclosure.

There are made-to-order services that accept custom-making of shirts, shoes, and the like (hereinafter, collectively referred to as clothing) online from a user. In addition, a specific suit for measuring a body shape and a body size of a user and an application linked with the suit, and the like are starting to be proposed.

Such a made-to-order service, automatic measurement, and the like certainly enable clothing that matches a hobby, a taste, and a body type of each user to be ordered. However, users of such services are mainly people who are undeniably passionate about clothes, and other so-called light users are a minority.

From a different perspective, it can be stated that there is a psychological hurdle to be overcome by such a light user before utilizing a conventional made-to-order service. For example, one of the causes of the psychological hurdle is that a user to perform various made-to-order operations must set a wide variety of items. In addition, whether or not a correct answer can be provided for each of such items entirely depends on the user, and it is difficult to design in a fashionably organized manner unless the user is reasonably knowledgeable and passionate about clothing or the like.

It is needless to say that systems for providing assistance in a custom-making operation in accordance with purchasing made-to-order clothing by such a user are being proposed. However, while such systems enable advice to be provided when custom-making, the user is no better off than using a conventional system in terms of having to personally consider and set made-to-order contents.

In other words, from the perspective of a general user who is not reasonably knowledgeable and passionate about clothing or the like, there is a problem in that a hurdle of utilizing a made-to-order service remains high. In consideration thereof, the present embodiment provides a system that makes a made-to-order service of clothing or the like readily utilizable regardless of knowledge and the like of a user.

Specifically, in the present embodiment, a purchase support server that provides a made-to-order service on a network stores and manages, in a storage unit, a user attribute of each user and made-to-order contents of clothing by the user. In addition, the purchase support server specifies another user who is associated with an attribute of a user to newly purchase made-to-order clothing based on the user attribute of each user being stored in the storage unit.

Furthermore, the purchase support server presents information on the made-to-order contents of the other user having been specified as described above to the user to newly purchase made-to-order clothing as a custom-making target of the clothing.

The user having viewed the information on a terminal performs a custom-making operation with respect to the made-to-order contents being displayed on a display of the terminal. For example, the custom-making operation may include at least one of items that can be designated when normally purchasing made-to-order clothing such as a type or a color of a fabric, a pattern or a character, shapes of a collar or cuffs, and a size of each portion.

On the other hand, the terminal accepts a custom-making operation by the user and notifies the purchase support server of contents of the custom-making operation. The purchase support server receives the notification and generates a made-to-order result by reflecting the contents of the custom-making operation onto made-to-order contents (of the other user). The purchase support server is to execute order processing of relevant clothing including the made-to-order result obtained in this manner.

As the purchase support server described above, in addition to a web server that provides a made-to-order service of clothing, a server that provides a web server providing a conventional made-to-order service with information based on a purchase support technique according to the present disclosure can also be assumed.

With a made-to-order service provided in such a mode, even in a case of a light user who is not particularly passionate or is unclear of his/her taste with respect to clothing, a made-to-order operation using a fashionably organized design can be realized by a simple custom-making operation based on made-to-order contents of another person (who is fashionable enough, whose order record is sufficient, or who is popular enough to be used as a reference).

### Configuration of Purchase Support System 1

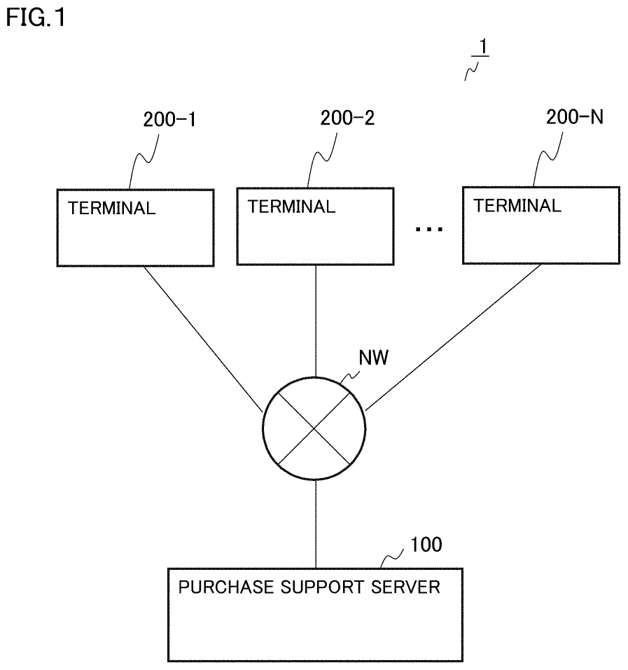

FIG. 1 is a configuration diagram of a purchase support system 1. A configuration of the purchase support system 1 according to a first embodiment will be described with reference to FIG. 1.

The purchase support system 1 includes a purchase support server 100 and terminals 200-1, 200-2, . . . , 200-N (where N is a natural number) which are connected to be capable of communicating with each other via a network NW. The network NW is constituted by a WAN (Wide Area Network), a LAN (Local Area Network), or the like. In the following description, the terminals 200-1, 200-2, . . . , 200-N will be described as a terminal 200 unless the terminals 200-1, 200-2, . . . , 200-N need to be distinguished from one another.

The purchase support server 100 is a server apparatus that provides a made-to-order service according to the present embodiment on the network NW. For example, the purchase support server 100 performs processing with respect to the terminal 200 having accessed the purchase support server 100 via the network NW such as accepting a made-to-order request, delivering a custom-making target (past made-to-order contents by another user with a same or similar attribute) in accordance with the made-to-order request, accepting a custom-making operation with respect to the custom-making target, and notifying a result of order processing of relevant clothing using a made-to-order result that reflects the custom-making operation.

On the other hand, the terminal 200 is an information processing terminal which accepts a custom-making operation by the user with respect to the custom-making target (past made-to-order contents) delivered from the purchase support server 100 as described above and which obtains a custom-making result of the user and an order processing result based thereon by notifying the purchase support server 100 of the accepted custom-making operation.

(Functional Configuration of Purchase Support Server 100)

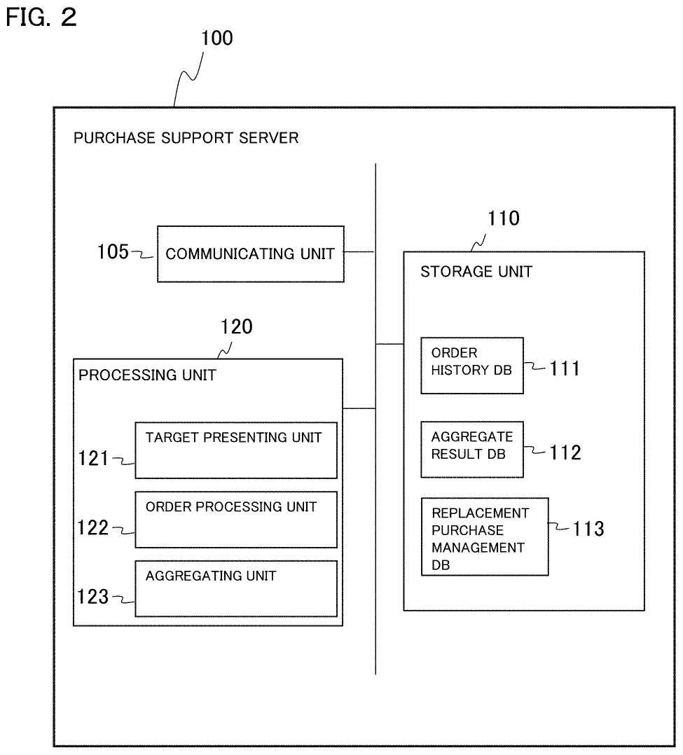

FIG. 2 is a functional block diagram showing an example of a functional configuration of the purchase support server 100. Alternatively, the purchase support server 100 according to the present embodiment may be configured by omitting a part of components (respective units) shown in FIG. 2.

The purchase support server 100 is an information processing apparatus including a communicating unit 105, a storage unit 110, and a processing unit 120.

Among these units, the communicating unit 105 performs various kinds of control for communicating with the terminal 200 via the network NW. A function thereof can be realized by hardware such as various kinds of processors or a communication ASIC (Application Specific Integrated Circuit) or by a program or the like.

In addition, the storage unit 110 is a storage apparatus for storing a program and various kinds of data that enable a computer to function. The storage unit 110 includes an order history DB 111, an aggregate result DB 112, and a replacement purchase management DB 113.

The order history DB 111 is a database that stores an order history in the made-to-order service according to the present embodiment. Examples of information stored in the order history DB 111 include a custom-making result generated in accordance with a made-to-order request previously accepted from the terminal 200 via the communicating unit 105, a result of order processing based on the custom-making result, and an attribute of a relevant user. Alternatively, the storage unit 110 may include a temporary storage area or a storage.

In addition, the aggregate result DB 112 is a database storing an aggregate result of data related to opinions expressed by others with respect to each made-to-order result generated for each user and which are disclosed on the network NW and information on an incentive to be given to a relevant user in accordance with the aggregate result.

The data related to the expressed opinions described above may include, in addition to opinions (for example, “like” or “dislike”) that simply represent a feeling of like or dislike, opinions corresponding to operations on an SNS (Social Network Service) such as a so-called recommend that is an article describing a recommendation to others, a follow with respect to the made-to-order result or a user having performed the custom-making operation, and a share in which the made-to-order result is cited.

In addition, the aggregate result described above may include, in addition to a scale (a total number or a frequency) of at least any of likes/dislikes, recommends, follows, and shares with respect to a made-to-order result, a concept of an order of popularity among made-to-order results that is determined in accordance with the scale.

Furthermore, the incentive described above is given to a user having performed a custom-making operation that is a source of a made-to-order result disclosed on the network NW in accordance with any event of a recommend, a follow, and a share with respect to the disclosed made-to-order result. Specifically, various points or money that can be used to settle a payment in a made-to-order service, goods representing various characters that appear in the made-to-order service, and complimentary coupons for purchasing the goods can be assumed.

In addition, the replacement purchase management DB 113 is a database storing information related to a replacement purchase time of clothing based on durability of material used in the clothing as indicated by the made-to-order result described above. For example, information stored in the replacement purchase management DB 113 is information on a purchase time and a next replacement purchase time of clothing with respect to a made-to-order result of each user. It should be noted that the replacement purchase management DB 113 is updated every time the user makes a replacement purchase or, in other words, places an order in the made-to-order service with respect to the clothing.

Furthermore, the processing unit 120 executes various kinds of information processing to be executed in the purchase support server 100. The processing unit 120 has a CPU (Central Processing Unit) and a memory, and various kinds of information processing are executed by having the CPU use the memory to execute an information processing program stored in the storage unit 110.

The processing unit 120 includes a target presenting unit 121, an order processing unit 122, and an aggregating unit 123.

Among these units, the target presenting unit 121 specifies another user associated with an attribute of a user having sent a made-to-order request based on the attribute information of each user in the order history DB 111 in the storage unit 110. In addition to general information such as an age, a gender, an area of residence, an occupation, a hobby, a favorite color, and a made-to-order record, various attributes can be assumed as the attribute of a user in this case including a fabric or a print or pattern thereof, a character, an icon, a phrase, or a pattern in various contents such as a game, anime, a motion picture, or the like which is liked or which has been selected or designated by the user.

In addition, the target presenting unit 121 outputs information of made-to-order contents of the other user specified at this point to the terminal 200 of the user described above as a custom-making target of clothing with respect to the user.

It should be noted that, when specifying the other user described above, the target presenting unit 121 preferably specifies another user who is associated with character information (information on a character liked by each user indicated by the attribute information of each user in the order history DB 111 or, in other words, character information) which is the same as or similar to character information selected by the user to purchase made-to-order clothing.

Same characters mean that, for example, identification information such as a name of the characters is the same. In addition, similar characters mean that, for example, various kinds of character information associated with characters match each other such as characters sharing a part of their names (for example, a first/last word in words constituting the names) or characters having different names but matching character types (for example, a Normal type, a Water type, a Dragon type, a Steel type, a Psychic type, or a Fairy type) or matching character categories (for example, Mouse, Flame, or Shellfish) in the contents.

In addition, based on durability of material used in the clothing as indicated by a made-to-order result, the target presenting unit 121 notifies the terminal 200 of the user described above of a replacement purchase time of the clothing. To this end, as information on the durability of the material, for example, the target presenting unit 121 acquires a number-of-years value of a material lifetime from the corresponding made-to-order result in the order history DB 111.

Furthermore, the target presenting unit 121 specifies a replacement purchase time by adding a predetermined ratio of the number-of-years value of the lifetime that represents information on the durability to a present time and date and notifies the user of the specified replacement purchase time. While a timing of the notification is not particularly limited, for example, a predetermined period prior to arrival of the replacement purchase time or a time point of order processing can be assumed.

In addition, the order processing unit 122 accepts, from the terminal 200, a custom-making operation with respect to the made-to-order contents output by the target presenting unit 121 described above to the terminal 200. The order processing unit 122 in this case is assumed to have delivered a screen including an interface for accepting a custom-making operation to the terminal 200.

Furthermore, the order processing unit 122 executes order processing of clothing using a made-to-order result obtained by reflecting the accepted custom-making operation onto the made-to-order contents described above. As the order processing, processing can be assumed in which an order telegram including the made-to-order result or, in other words, information such as a fabric, a color, sizes of respective parts, and a design (A-type, Y-type, or the like in accordance with a body shape or the like) of the clothing is transmitted to a predetermined order-receiving system or the like.

As the fabric of the clothing described above, in addition to fabrics of existing colors and patterns, fabrics on which is printed or embroidered a character designated by the user by a custom-making operation or a preferred character indicated by the attribute information of the user can also be assumed.

As the order-receiving system described above, a business system operated by a business operator who contracts to produce made-to-order clothing is assumed. Once the order-receiving system receives the order telegram described above, the order-receiving system notifies related departments of the business operator of the order telegram as a production instruction. It is needless to say that the order system may be integrated with the purchase support server 100 or constitute a part of functions of the purchase support server 100.

In addition, the order processing unit 122 preferably outputs the made-to-order result described above and the presence or absence or the number of other users having purchased same or similar made-to-order clothing to the terminal 200 during the custom-making operation described above.

If a made-to-order result based on a custom-making operation performed by a user himself/herself turns out to be remarkably similar to made-to-order contents already been purchased by another user, the significance of purchasing made-to-order clothing such as differentiating himself/herself from others as a way of expressing individuality may diminish. Such a need to avoid a so-called “overlap” exists regardless of whether a user of the made-to-order service is a heavy user or a light user.

In consideration thereof, the user can effectively avoid an “overlap” by recognizing the presence or absence or the number of other users having purchased made-to-order clothing that is the same as or similar to the made-to-order result by the user and, when the number of such other users exceeds a limit conceived by the user (in other words, a number that causes the user to conceive that there is an “overlap”), by performing a further custom-making operation.

At this point, in order to further effectively avoid such an “overlap”, preferably, the order processing unit 122 further narrows down other users having purchased the same or similar made-to-order clothing based on a location of the other users (which can be specified by an item of “attribute information of user” in the order history DB 111 and which may include both a concept of an address and a concept of a present position).

In this case, for example, when the user to purchase made-to-order clothing or the like at this time lives in the Tokyo metropolitan area, the order processing unit 122 narrows down other users having purchased the same or similar made-to-order clothing or the like to those whose locations are the Tokyo metropolitan area. Accordingly, the user to purchase made-to-order clothing or the like is to be informed of the presence or absence or the number of only those the user can encounter nearby among the people wearing clothing or the like with a design that is remarkably similar to the user's own made-to-order contents. In other words, the significance of purchasing made-to-order clothing or the like is expected to be reinforced.

On the other hand, from the perspective of a user living in the Tokyo metropolitan area, if other users having purchased made-to-order clothing that is the same as or similar to the made-to-order contents of the user are located far away (for example, Hokkaido, Kyushu, or overseas) (in other words, when the made-to-order contents are popular in the faraway regions), it is predicted that opportunities where the user experiences an emotion such as “I feel embarrassed because I met someone wearing the same design” will be minimal.

Furthermore, narrowing down other users by recency of order times by the other users instead of or in addition to narrowing down the other users by location as described above is also preferable. In this case, for example, the order processing unit 122 narrows down the other users described above to those of which made-to-order contents within the last two years (which can be specified by an item of “order date” in the order history DB 111) are determined to be same/similar. In other words, other users specified to have purchased the same or similar made-to-order clothing based on made-to-order purchases prior to the last two years are excluded.

Even if there have been many other users having purchased the same or similar made-to-order clothing or the like in the past, when it is assumed that the clothing or the like are no longer being worn at the present time in relation to fabric lifetime (and since a replacement purchase has not been made), it is safe to say that the presence of such other users need not be taken into consideration from the perspective of avoiding an “overlap”.

When outputting information of made-to-order contents of another user as a custom-making target, in addition to outputting the information of the made-to-order contents to the terminal 200 of a user having made a made-to-order request, the target presenting unit 121 may also output the information of the made-to-order contents to the terminal 200 of a user designated by the user having made the made-to-order request.

In other words, a situation is created where many other people are asked to perform custom-making operations instead of just the user having made the made-to-order request. As the designated user in this case, a case of a family member or an acquaintance of the user having made the made-to-order request, a case of another user purchasing made-to-order clothing that matches the user's taste, or a case of a user whose popularity order (to be described later) in the made-to-order service is high can be assumed.

In such a case, the order processing unit 122 accepts custom-making operations from respective terminals 200 of the user and the designated user and executes order processing using made-to-order results obtained by reflecting the custom-making operations received from the respective terminals 200 onto made-to-order contents that are a custom-making target.

In addition, the aggregating unit 123 discloses made-to-order results obtained by the target presenting unit 121 and the order processing unit 122 described above on a made-to-order service site on the network NW or the like and performs processing steps of accepting expressed opinions with respect to the disclosed made-to-order results from many and unspecified users of the made-to-order result service, aggregating the expressed opinions, and disclosing a result of the aggregate on the network NW.

The expressed opinions described above may include, in addition to opinions (for example, “like” or “dislike”) that simply represent a feeling of like or dislike, opinions corresponding to operations on an SNS (Social Network Service) such as a so-called recommend that is an article describing a recommendation to others, a follow with respect to the made-to-order result or a user having performed the custom-making operation, and a share in which the made-to-order result is cited.

In addition, as the processing of aggregate described above, with respect to a scale of at least any of likes/dislikes, recommends, follows, and shares that represent the expressed opinions described above, processing for counting a total number or a frequency thereof can be assumed. Furthermore, in addition to such processing, the processing of aggregate may include a concept of determining a popularity order among made-to-order results determined in accordance with such scales.

Furthermore, when disclosing the result of the aggregate described above on the network NW, the aggregating unit 123 specifies a popularity order among made-to-order results in accordance with a scale of at least any of likes/dislikes, recommends, follows, and shares with respect to made-to-order results that represent the result of the aggregate and discloses made-to-order results of a predetermined popularity order or higher among the made-to-order results as popular designs.

In addition, the aggregating unit 123 performs processing for giving a predetermined incentive to the user having performed a custom-making operation that is a source of a made-to-order result disclosed on the network NW in accordance with any event of a like/dislike, a recommend, a follow, and a share with respect to the disclosed made-to-order result.

Furthermore, the incentive described above is given to the user having performed a custom-making operation that is a source of a made-to-order result disclosed on the network NW in accordance with any event of a recommend, a follow, and a share with respect to the disclosed made-to-order result.

Specifically, various points or money that can be used to settle a payment in a made-to-order service, goods representing various characters that appear in the made-to-order service, and complimentary coupons for purchasing the goods can be assumed.

It should be noted that, in the present embodiment, a “server” is a term that means, in addition to a single information processing apparatus (in other words, a server apparatus), an entire server apparatus group (in other words, a server system) when a server is constituted by a plurality of server apparatuses. In addition, in the present embodiment, while the purchase support server 100 will be described as an integral construction, the purchase support server 100 may be a construction including a plurality of server apparatuses divided according to function and/or role.

(Functional Configuration of Terminal 200)

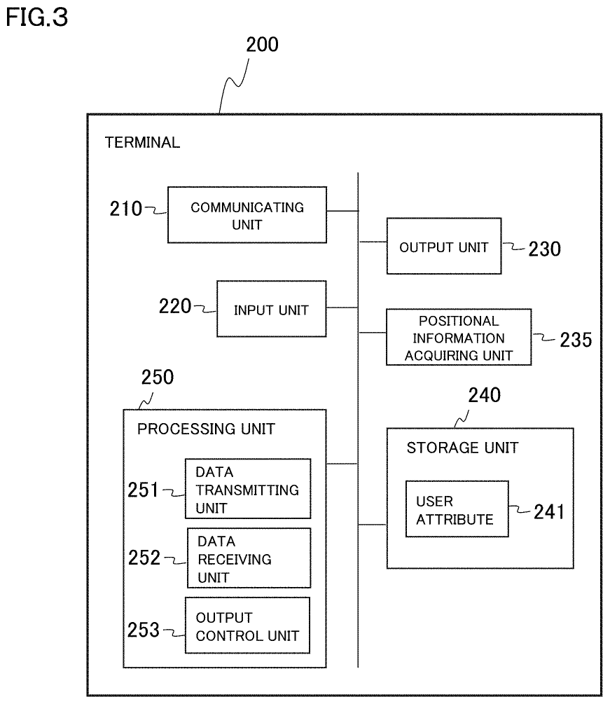

FIG. 3 is a functional block diagram showing an example of a functional configuration of the terminal 200. Alternatively, the terminal 200 according to the present embodiment may be configured by omitting a part of components (respective units) shown in FIG. 3.

The terminal 200 is an information processing apparatus that corresponds to a terminal owned by a user and, in the present embodiment, the terminal 200 is, for example, a smartphone, a feature phone, a tablet computer, a laptop computer, a desktop computer, a portable game machine, a stationary game machine, a wearable terminal such as a head-mounted display, or a multifunctional device such as a multifunctional television receiver (a smart television) equipped with an information processing function.

In other words, the terminal 200 has various functions (for example, an input function, an output (display) function, an information processing function, a network communication function, a sensor function, a call function, and a camera function) which are included in a general multifunctional device. The network communication function is a function that enables communication via the Internet or the like and/or a function that enables communication via a mobile communication network.

The terminal 200 includes a communicating unit 210, an input unit 220, an output unit 230, a positional information acquiring unit 235, a storage unit 240, and a processing unit 250.

The communicating unit 210 performs various kinds of control for communicating with the purchase support server 100 via the network NW and a function thereof can be realized by hardware such as various kinds of processors or a communication ASIC or by a program or the like.

The input unit 220 is an interface for accepting an input from the user and sends the user's input to the processing unit 250. For example, the input unit 220 is a touch panel, a button, a controller, or the like.

Alternatively, the input unit 220 may be a measuring instrument that detects various states of the terminal 200. For example, the input unit 220 may be a sound sensor that picks up sound of surroundings of the terminal 200, an attitude sensor (an acceleration sensor or a gyroscope sensor) that detects an attitude or an inclination of the terminal itself, an eye-gaze sensor that detects a direction of a line of sight of the user, a photosensor that detects brightness of the surroundings, a UV sensor that detects an amount of ultraviolet included in sunlight or the like, or an infrared sensor that detects a motion of the user.

In addition, the input unit 220 may be an image sensor that extracts an imageable feature of an object from video captured by a camera (not illustrated), a humidity sensor that detects humidity of the surroundings of the terminal 200, a geomagnetic sensor that detects a magnetic field at a location of the terminal 200, a proximity sensor that detects an object in a vicinity of the terminal 200, an illuminance sensor that brightness of the surroundings of the terminal 200, or the like. The input unit 220 sends detected sensing data to the processing unit 250 as a user's input.

The output unit 230 is, for example, a display apparatus such as a display or an audio output apparatus such as a speaker, and displays or outputs various kinds of images or audio generated by the terminal 200 in accordance with an input with respect to the input unit 220 or displays or outputs various kinds of images or audio based on data received from the purchase support server 100.

The output unit 230 described above includes an artificial intelligence-mounted speaker (a smart speaker). In addition, the output unit 230 may include a vibrator that vibrates the terminal 200 or lighting that emits light.

The positional information acquiring unit 235 acquires positional information of the terminal 200 or, in other words, the user as, for example, one piece of attribute information of the user. For example, the positional information acquiring unit 235 is a GPS (Global Positioning System) sensor (for example, a GPS module) and detects a position using a GNSS (Global Navigation Satellite System).

It should be noted that a positional information acquisition method that is employed by the positional information acquiring unit 235 is arbitrary and, for example, the positional information acquiring unit 235 may acquire positional information using a beacon. In addition, for example, when the terminal 200 communicates with a specific access point, the positional information acquiring unit 235 may detect acquirable positional information from the access point.

Furthermore, the positional information acquiring unit 235 may detect a position at which the terminal 200 is estimated to be present based on identification information (such as an IP address) upon the terminal 200 connecting to the Internet.

The positional information acquiring unit 235 may send acquired positional information to the processing unit 250 as attribute information related to the user. In addition, the positional information acquiring unit 235 may calculate information indicating an altitude of the user (for example, information indicating a floor number of a building) by calculating a change in altitude based on a detection result of an atmospheric pressure sensor. This information can also be used as attribute information related to the user.

The storage unit 240 is a storage apparatus for storing a program and various kinds of data that enable a computer to function. The storage unit 240 may include a temporary storage area or a storage.

The storage unit 240 is capable of storing attribute information of a user of the present terminal 200, made-to-order contents that are custom-making targets having been delivered from the purchase support server 100, and the like.

In addition, the processing unit 250 executes various kinds of information processing to be executed in the terminal 200. The processing unit 250 has a CPU and a memory. In the terminal 200, necessary processing is executed by having the CPU use the memory to execute a program stored in the storage unit 240. In addition, when the terminal 200 operates as a multifunctional device, the processing unit 250 executes information processing for realizing the respective functions.

The processing unit 250 includes a data transmitting unit 251, a data receiving unit 252, and an output control unit 253. Among these units, the data transmitting unit 251 controls the communicating unit 210 so as to transmit data (for example, a made-to-order request or attribute information of the user) related to an input by the user accepted by the input unit 220 to the purchase support server 100.

In addition, the data transmitting unit 251 may control the communicating unit 210 so as to transmit positional information acquired by the positional information acquiring unit 235 to the purchase support server 100 as attribute information of the user.

On the other hand, the data receiving unit 252 accepts, via the communicating unit 210, made-to-order contents that are custom-making targets having been delivered from the purchase support server 100, a made-to-order result reflecting a custom-making operation with respect to the made-to-order contents, an order processing result, and the like.

In addition, the output control unit 253 controls the output unit 230 so as to output an image (including concepts of both a moving image and a still image), a sound, a vibration, or the like on a screen related to purchasing made-to-order clothing or the like based on data accepted by the data receiving unit 252.

While the purchase support server 100 performs control related to main processing steps in the purchase support system 1 according to the present embodiment as described above, alternatively, the processing may be performed by the terminal 200 provided with similar functions. Specifically, a configuration may be adopted in which at least a part of functional units included in the purchase support server 100 is not provided in the processing unit 120 of the purchase support server 100 but provided in the processing unit 250 of the terminal 200.

### Processing in Purchase Support Server 100

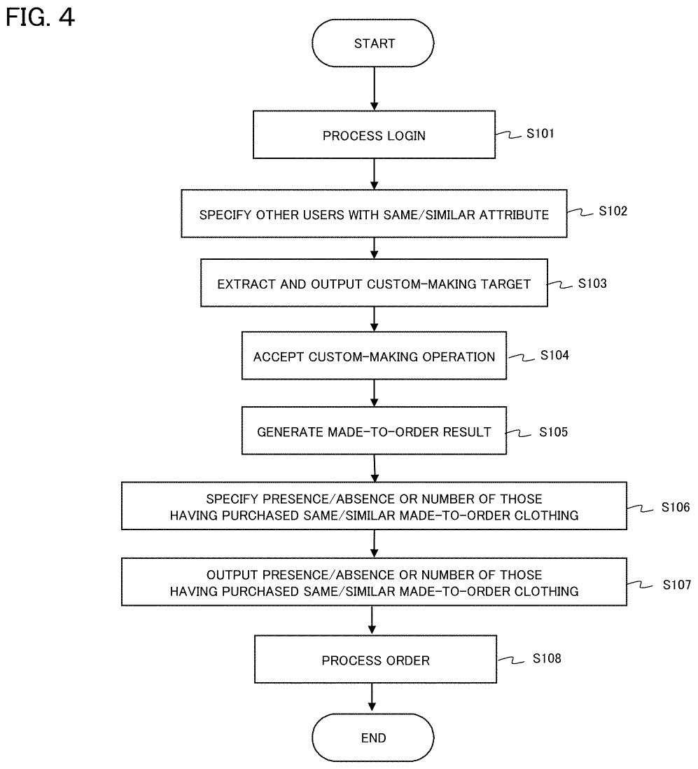

FIG. 4 is a flow chart showing an example of processing in the purchase support server 100. An example of processing in the purchase support server 100 will be described with reference to FIG. 4.

In step S101, the target presenting unit 121 of the purchase support server 100 accepts a login request from the terminal 200 via the communicating unit 105 and performs login processing. For example, the target presenting unit 121 accepts information for login such as a user ID that identifies a user, a password, and the like from the terminal 200 and refers to information related to the user being stored in the order history DB 111 of the storage unit 110 to authenticate the user. When the user is normally authenticated, the target presenting unit 121 updates user information such as a login history.

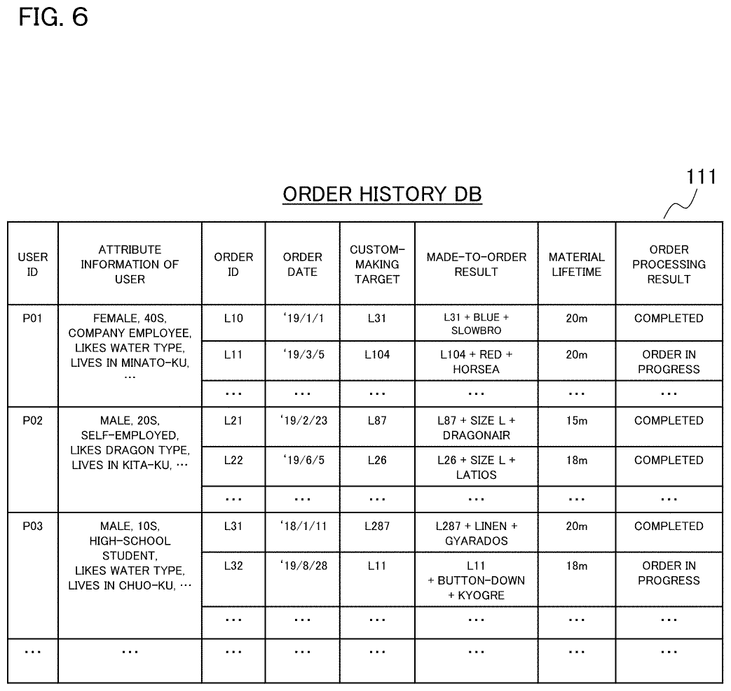

FIG. 6 is a diagram showing an example of the order history DB 111. In FIG. 6, each record in the order history DB 111 includes as items, with a user ID as a key, attribute information of the user, an order ID, an order date, a custom-making target, a made-to-order result, a material lifetime, and an order processing result.

Among these items, the user ID is information that uniquely identifies the user having made a made-to-order request. In addition, the attribute information may include information such as a gender, an age group, and an occupation of the user, a character or a character type which is liked by the user and which has been acquired from a game server (not illustrated), a present location (or address), and a fabric or a print or a pattern thereof. Among such information, information on a character or a character type liked by the user corresponds to character information. In the example shown in FIG. 6, as an example of character information, with respect to a user “P01”, it is shown that a liked character type is “Water type” and characters included as an actual made-to-order result (liked characters) are “Slowbro” and “Horsea”. In other words, it is shown that “Slowbro” and “Horsea” are associated as characters of the “Water type”.

In addition, with respect to a user “P02”, it is shown that a liked character type is “Dragon type” and characters included as an actual made-to-order result (liked characters) are “Dragonair” and “Latios”. In other words, it is shown that “Dragonair” and “Latios” are associated as characters of the “Dragon type”. Furthermore, with respect to a user “P03”, it is shown that a liked character type is “Water type” and characters included as an actual made-to-order result (liked characters) are “Gyarados” and “Kyogre”. In other words, it is shown that, besides “Slowbro” and “Horsea”, “Gyarados” and “Kyogre” are also associated as characters of the “Water type”.

Such information related to classification of characters based on character types is assumed to be stored in, for example, the storage unit 110 of the purchase support server 100. For example, by collating “Slowbro” and “Horsea” indicated by respective made-to-order results by the user “P01” with the information related to classification described above, the purchase support server 100 can specify that the character types of the characters are both “Water type”. Therefore, the purchase support server 100 can recognize that the user “P01” has selected a character of the “Water type” for each made-to-order purchase and set the liked character type in the attribute information described above to the “Water type”.

In addition to a mode of specifying information describing that a certain type is a character type liked by a user solely based on past made-to-order results related to the user, a mode of accepting a designation of a character type liked by a user when (or prior to) receiving a made-to-order request from the user or a mode of making a determination based on game information (for example, including information on a character type of a used character) obtained from a server of an online game in which the character appears can also be adopted.

Furthermore, the order ID is identification information that uniquely identifies each order placed by the user. Moreover, the order date is the date on which the order request had been accepted from the terminal 200.

In addition, the custom-making target indicates made-to-order contents that are a custom-making target presented by the purchase support server 100 at the time of the made-to-order request by the user. In the present embodiment, the order ID of made-to-order contents that had become a custom-making target is exemplified as a value of the made-to-order contents.

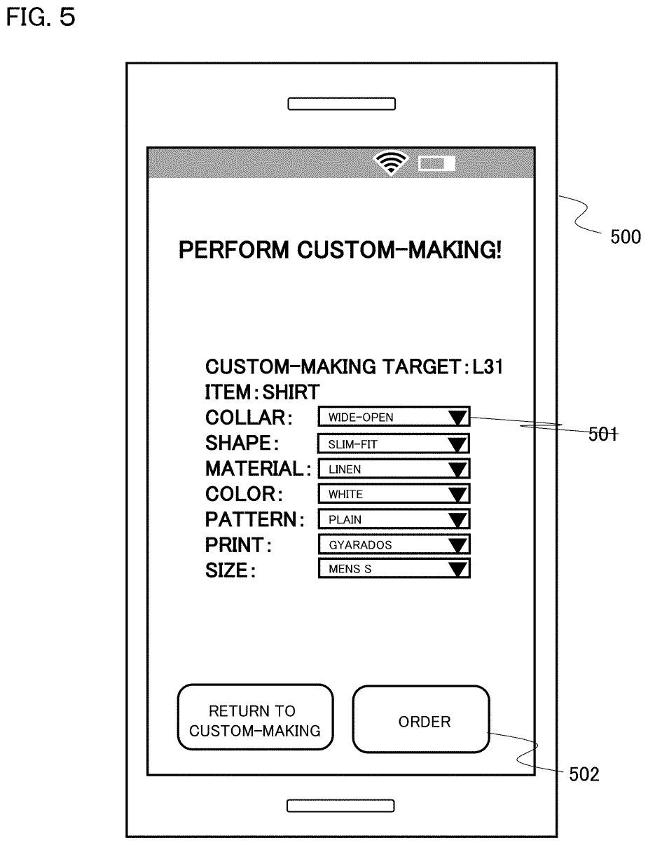

Furthermore, the made-to-order result indicates contents of a custom-making operation performed by the user described above with respect to the made-to-order contents that are the custom-making target described above. The example shown in FIG. 5 expresses the made-to-order result in a mode where values such as a material or a color thereof, a character printed on the material, or a size or a shape of clothing which are contents of a custom-making operation are added by “+” to the order ID corresponding to the custom-making target.

In addition, the material lifetime indicates a period of a lifetime (in the example in the diagram, number of months) determined in advance with respect to the material of clothing indicated by the made-to-order result. It is assumed that the purchase support server 100 separately stores lifetime information for each material as the value of the material lifetime and every time a made-to-order result is determined (in other words, every time a material is determined by the user), the purchase support server 100 acquires the value from the lifetime information and sets the value.

Furthermore, the order processing result indicates a status of order processing in consideration of the made-to-order result described above. In the example shown in FIG. 6, respective values of “completed” indicating that order processing has been completed and “order in progress” indicating that order processing is in progress are set. With respect to order processing having been completed, for example, a situation where the order-receiving system described above has received an order and production work of the clothing has already been started or a situation where both production and shipment of the clothing have been completed can be assumed. In addition, with respect to order processing in progress, for example, a situation where the order-receiving system described above has simply received an order or a situation where production of the clothing is in progress can be assumed.

Returning to FIG. 4, in step S102, the target presenting unit 121 specifies another user associated with an attribute of the user having logged in in step S101 or, in other words, the user to purchase made-to-order clothing or the like based on the attribute information of each user in the order history DB 111 in the storage unit 110.

When specifying the other user described above, the target presenting unit 121 specifies another user who is associated with character information that is the same as or similar to character information selected by the user to purchase made-to-order clothing or the like in addition to attributes such as a gender, an age group, an occupation, and a location (derived from the present location obtained by the positional information acquiring unit 235 of the terminal 200) based on information on a character liked by each user as indicated by the attribute information of each user in the order history DB 111 of the storage unit 110.

In step S103, the target presenting unit 121 extracts information of past made-to-order contents with respect to the other user specified in step S102 from the order history DB 111 and outputs the extracted information to the terminal 200 of the user described above as a custom-making target of clothing.

At this point, in addition to the terminal 200 of the user described above, the target presenting unit 121 may also output the information of the made-to-order contents to the terminal 200 of a user designated by the user.

In step S104, the order processing unit 122 accepts, from the terminal 200 through, for example, a screen 500 shown in FIG. 5, a custom-making operation related to various items such as a type or a color of a material, a size or shape of clothing, and a character to be printed with respect to the made-to-order contents output by the target presenting unit 121 to the terminal 200 (or to the terminal 200 of the designated user).

On the screen 500 shown in FIG. 5, for example, a pull-down menu 501 is arranged as an interface for accepting a custom-making operation with respect to each item. The user is to select a desired setting value by operating the pull-down menu 501 of each item.

In step S105, the order processing unit 122 reflects the custom-making operation accepted in step S104 onto the made-to-order contents that are a custom-making target and generates a made-to-order result. In the example indicated by the order history DB 111 shown in FIG. 6, data created by adding respective values of the items changed by the custom-making operation to an order ID corresponding to the custom-making target is generated as the made-to-order result.

When the made-to-order contents that are a custom-making target are also output to the terminal 200 of the designated user and a custom-making operation of the designated user is accepted, the order processing unit 122 in S105 generates made-to-order results by reflecting a custom-making operation accepted from respective terminals 200 of the user and the designated user onto the made-to-order contents.

In step S106, the order processing unit 122 specifies a presence or absence or the number of other users having purchased made-to-order clothing that is same as or similar to the made-to-order result obtained in S105. Specifically, the number of such other users can be specified by searching for records of which contents of a made-to-order result are the same in the order history DB 111 and counting the number of retrieved records.

In order to further effectively avoid an “overlap”, the order processing unit 122 in step S106 described above preferably further narrows down other users having purchased the same or similar made-to-order clothing based on a location of the other users (which can be specified by an item of “attribute information of user” in the order history DB 111 and which may include both a concept of an address and a concept of a present position).

In this case, for example, when the user to purchase made-to-order clothing or the like at this time lives in the Tokyo metropolitan area, the order processing unit 122 narrows down other users having purchased the same or similar made-to-order clothing or the like to those whose locations are the Tokyo metropolitan area. Accordingly, the user to purchase made-to-order clothing or the like is to be informed of the presence or absence or the number of only the people the user can encounter nearby among those wearing clothing or the like with a design that is remarkably similar to the user's own made-to-order contents. In other words, the significance of purchasing made-to-order clothing or the like is expected to be reinforced.

On the other hand, from the perspective of a user living in the Tokyo metropolitan area, if other users having purchased made-to-order clothing that is the same as or similar to the made-to-order result of the user are located far away (for example, Hokkaido, Kyushu, or overseas) (in other words, when the made-to-order contents are popular in the faraway regions), it is predicted that opportunities where the user experiences an emotion such as “I feel embarrassed because I met someone wearing the same design” will be minimal.

Furthermore, narrowing down other users by recency of order times by the other users instead of or in addition to narrowing down the other users by location as described above is also preferable. In this case, for example, the order processing unit 122 narrows down the other users described above to those of which made-to-order contents within the last two years (which can be specified by an item of “order date” in the order history DB 111) are determined to be same/similar. In other words, other users specified to have purchased the same or similar made-to-order clothing based on made-to-order records older than the last two years are excluded.

Even if there have been many other users having purchased the same or similar made-to-order clothing or the like in the past, when it is assumed that the clothing or the like is no longer being worn at the present time in relation to fabric lifetime (and since a replacement purchase has not been made), it is safe to say that the presence of such other users need not be taken into consideration from the perspective of avoiding an “overlap”.

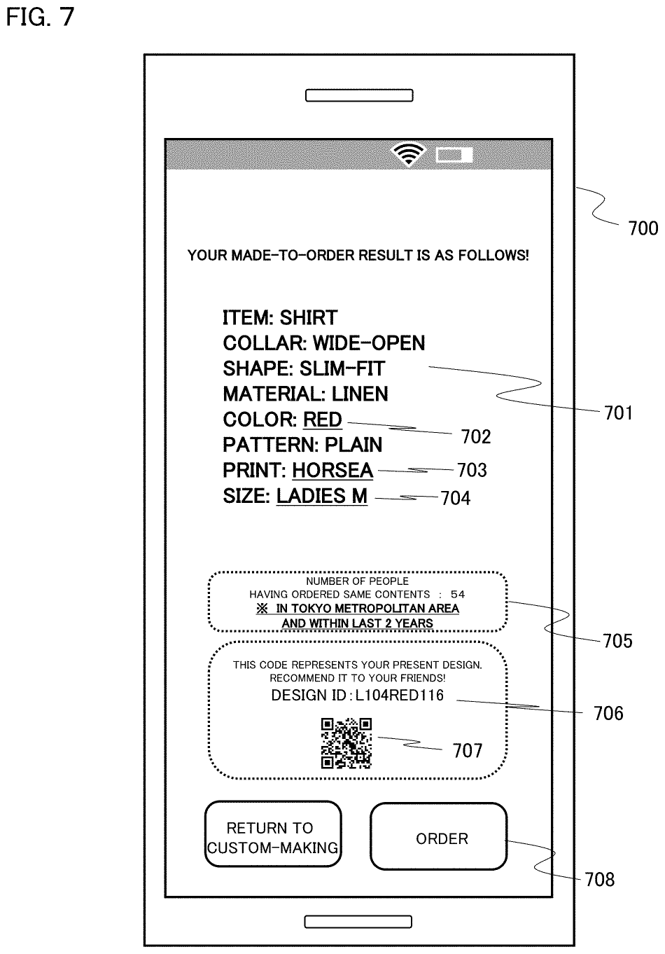

In step S107, the order processing unit 122 outputs the information (a screen 700 shown in FIG. 7) on the presence or absence or the number of other users specified in step S106 to the terminal 200 of the user described above. In an example indicated by the screen 700 shown in FIG. 7, information 705 on the number of other users specified in step S106 is described together with a made-to-order result 701.

The example shown in FIG. 7 displays other users “in the Tokyo metropolitan area and within last two years” as a condition of the other users specified in step S106. As the condition, for example, a condition designated in advance by the user to purchase made-to-order clothing or the like at this time or a condition specified by a manager of the purchase support server 100 or the like can be assumed. As described above, by presenting the presence or absence or the number of other users having purchased the same or similar made-to-order clothing or the like who have a possibility of an actual encounter based on a relationship of physical distance and who can conceivably still be wearing the clothing or the like instead of the number of all other users having purchased the same or similar made-to-order clothing or the like, the user can evaluate his/her own made-to-order contents while narrowing down targets of avoiding an “overlap” to a realistically meaningful range.

On the other hand, considering all other users having purchased the same or similar made-to-order clothing or the like as targets without narrowing down the other users as described above may make it difficult to avoid an “overlap” no matter how the user selects made-to-order contents. Therefore, as the number of users of the made-to-order service or the frequency of made-to-order requests made via the purchase support server 100 increases, the narrow-down processing described above is more preferably performed.

In addition, in the made-to-order result 701 on the screen 700, each of items 702 to 704 on which a custom-making operation by the relevant user (including a designated user) has been performed is underlined to highlight the item.

Alternatively, on the screen 700, the order processing unit 122 may output a design ID 706 indicating a made-to-order result or, in other words, design contents in addition to the made-to-order result 701 of the user described above or the information 705 on the number of other users. The design ID is identification information that uniquely indicates design contents that represent a made-to-order result and, in the example shown in FIG. 7, “L104RED116” represents a design which is based on an order “L104” and which adopts “RED” as a color and “116” as a character. In this case, “116” is an identification number of the character. Naturally, it is assumed that the purchase support server 100 manages information on each character in association with the identification number of the character in the storage unit 110.

In addition, the order processing unit 122 may display, on the screen 700, a two-dimensional code 707 obtained by applying a value combining a URL of a made-to-order site with the design ID described above to a predetermined conversion algorithm. As far as the user or an acquaintance or the like of the user is concerned, reading the two-dimensional code 707 with a predetermined terminal enables the made-to-order site to be accessed in a hassle-free and speedy manner and made-to-order clothing or the like based on the design to be purchased or an order therefor to be placed in an extremely simple manner. It is needless to say that the user described above can readily recommend his/her own design to an acquaintance or the like.

The order processing unit 122 may cause an instruction to print the two-dimensional code 707 described above on relevant clothing to be included in order processing (S108 described below). In this case, an official order including the instruction is to be issued to a business operator contracted to produce the made-to-order clothing. Upon receiving the instruction, for example, the business operator prints the two-dimensional code 707 described above on a prescribed position of the clothing such as a tag or a lining. Clothing or the like on which the two-dimensional code 707 is printed through such processing similarly enables the made-to-order site to be accessed in a hassle-free and speedy manner and made-to-order clothing or the like based on the design to be purchased or an order therefor to be placed in an extremely simple manner when the user reorders or repurchases the made-to-order clothing or the like or when an acquaintance or the like having looked at the made-to-order clothing or the like orders or purchases the made-to-order clothing or the like.

In step S108, for example, the order processing unit 122 accepts a depression of an order button 708 on the screen 700 shown in FIG. 7 from the terminal 200 and executes order processing of the clothing using the made-to-order result 701. In accordance with the order processing, the order processing unit 122 is to register a record including contents in accordance with the order in the order history DB 111.

After the order processing described above, production work of the clothing is officially ordered and the clothing of which production has been completed is shipped to the user. The clothing having been delivered to the user is used and incurs deterioration caused by aging and damage accompanying use. Therefore, a situation where the clothing can no longer withstand normal use by the user is expected to occur at least before the lifetime of a material of the clothing expires.

In consideration thereof, based on durability of material used in the clothing as indicated by the made-to-order result described above, the target presenting unit 121 of the purchase support server 100 manages a replacement purchase time of the clothing and issues a notification recommending a replacement purchase when a predetermined period arrives to the terminal 200.

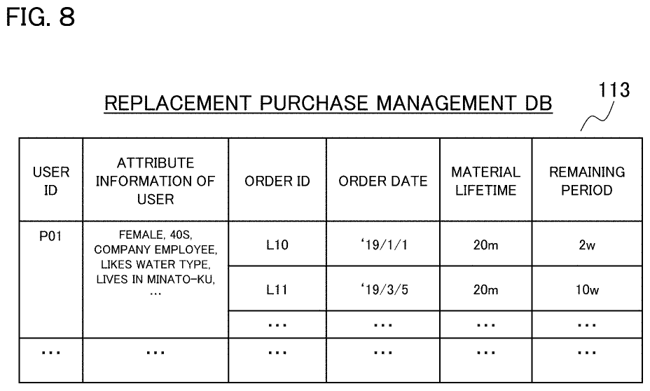

To this end, the purchase support server 100 stores the replacement purchase management DB 113 as shown in FIG. 8. The replacement purchase management DB 113 is constituted by records which associate, with a user ID as a key, values such as attribute information of the user, an order ID, an order date, a material lifetime, and a remaining period of the lifetime. Among these values, the remaining period can be calculated as a period between a date obtained by adding a period value of the material lifetime to the order date and the present date.

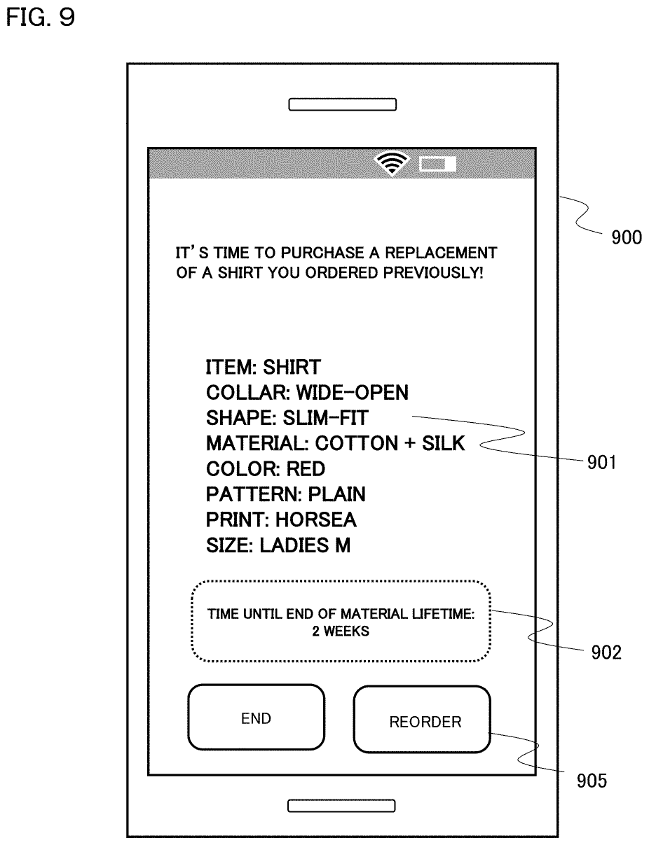

The target presenting unit 121 is configured to update the value of the remaining period in each record in the replacement purchase management DB 113 every time the date changes, and when the remaining period reaches a predetermined criterion (for example, two weeks), transmit a notification (a screen 900 shown in FIG. 9) that recommends a replacement purchase to the terminal 200 of the user.

The screen 900 shown in FIG. 9 displays a remaining period 902 until the lifetime expires in addition to a made-to-order result 901. The user checks a value of the remaining period 902 and considers whether or not to replace clothing that the user likes. When the user decides to repurchase the clothing, the user depresses a reorder button 905 on the terminal 200. On the other hand, in response to the depression of the reorder button 905, the order processing unit 122 executes order processing using the made-to-order result 901.

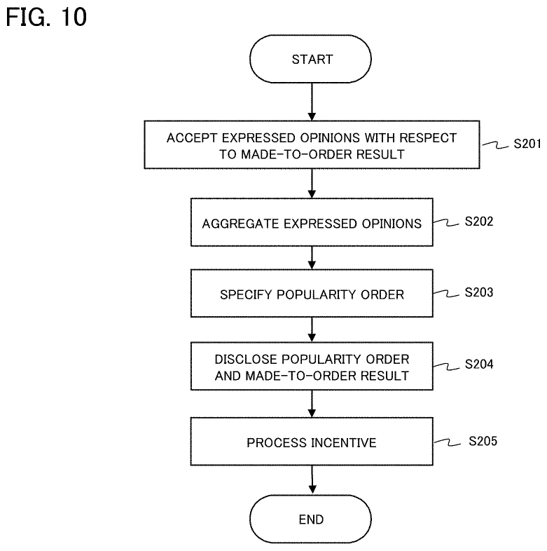

Next, a processing flow in the aggregating unit 123 will be described with reference to FIG. 10. For example, it can be assumed that the flow is executed after the flow shown in FIG. 4 and described above is completed or executed in parallel with the flow shown in FIG. 4. In step S201 of the flow shown in FIG. 10, the aggregating unit 123 discloses the made-to-order result obtained by the flow shown in FIG. 4 on the network NW and accepts expressed opinions with respect to the disclosed made-to-order result from the terminal 200 of each of many and unspecified users. Any of likes/dislikes, recommends, follows, and shares with respect to the disclosed made-to-order result correspond to the expressed opinions.

In step S202, the aggregating unit 123 accumulates the expressed opinions accepted in S201 for every predetermined period in the storage unit 110, performs an aggregate in which, for example, the number of positive expressed opinions among the stored expressed opinions is counted, and stores a result of the aggregate in the aggregate result DB 112.

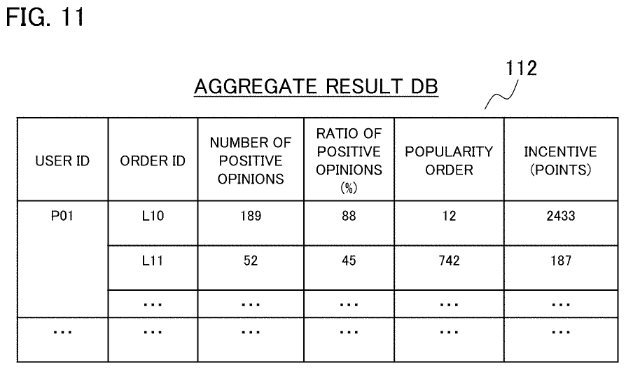

FIG. 11 is a diagram showing an example of the aggregate result DB 112. The aggregate result DB 112 shown in FIG. 11 is constituted by pieces of information which associate, with a user ID and an order ID in the order history DB 111 shown in FIG. 6, values such as the number of positive opinions, a ratio of positive opinions, a popularity order, and an incentive.

Among these values, the number of positive opinions is the number of positive expressed opinions counted in S202, and the ratio of positive opinions is a ratio of the number of positive opinions to the total number of expressed opinions. In addition, as the popularity order, for example, an algorithm can be assumed in which a height order among all made-to-order results is determined with respect to each of the number of positive opinions and the ratio of positive opinions and whichever is higher is adopted as the popularity order of the made-to-order result. While the popularity order indicates a degree of popularity among made-to-order results, the popularity order can also be considered a degree of popularity of the user having generated the made-to-order result.

In step S203, based on the number of positive opinions or the ratio of positive opinions described above that represents a result of the aggregate in step S202, the aggregating unit 123 specifies a popularity order among the made-to-order results as explained above in the description of the aggregate result DB 112.

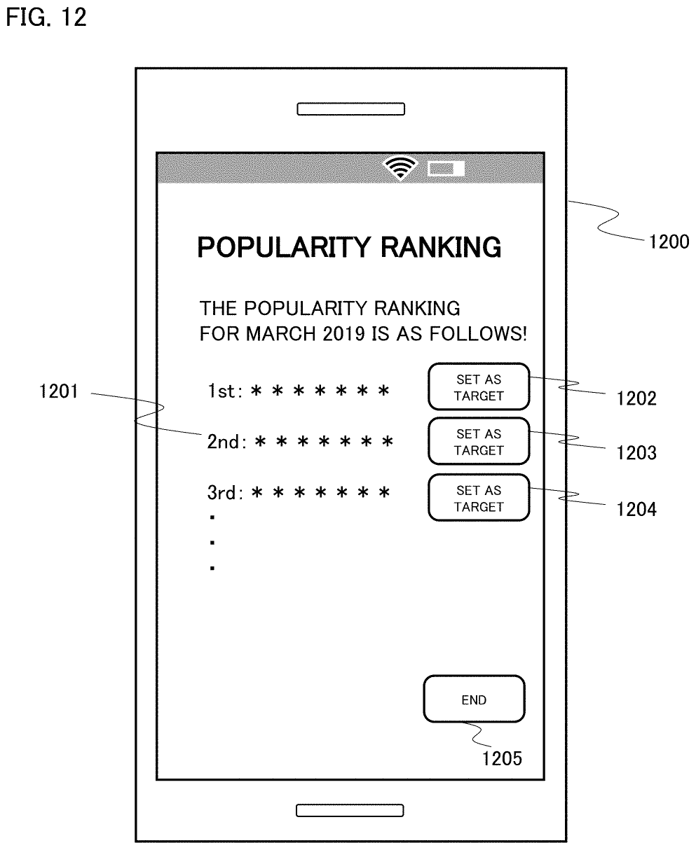

In step S204, based on the popularity order obtained in step S203, the aggregating unit 123 discloses (a screen 1200 shown in FIG. 12) a made-to-order result of a predetermined popularity order among the made-to-order results as a popular design on the network NW. On the screen 1200, buttons 1202 to 1204 for designating a custom-making target based on ranked made-to-order results are arranged and a designation of a custom-making target by the user can be accepted.

In step S205, the aggregating unit 123 executes processing for giving a predetermined incentive to the user having performed a custom-making operation that is a source of a made-to-order result disclosed on the network NW in accordance with any event of a like/dislike, a recommend, a follow, and a share with respect to the disclosed made-to-order result.

Specifically, as the incentive described above, the aggregating unit 123 applies the number or frequency of the events described above or the number of positive opinions or the ratio of positive opinions that represents contents of such events to a conversion rule determined in advance to specify various points or money that can be used to settle a payment in a made-to-order service, goods representing various characters that appear in the made-to-order service, complimentary coupons for purchasing the goods, or the like.

In addition, the incentive described above is given to the user having performed a custom-making operation that is a source of the made-to-order result and is managed by storing a value in an incentive field of the aggregate result DB 112.

As described above, the present embodiment enables, in a made-to-order service of clothing, clothing based on made-to-order contents of other people with similar hobbies or taste to be custom-made and enables fashionable clothing that matches the preferences of a user to be ordered by simple operations. In doing so, depending on needs of the user, an “overlap” with other users can also be avoided.

In addition, by engaging in custom-making in collaboration with other users, made-to-order clothing can be purchased using a design that takes knowledge of a larger number of users into consideration.

Furthermore, giving incentives or displaying rankings in accordance with recommending a made-to-order result to others or enabling others to utilize the made-to-order result also enables motivation toward custom-making to be sustained and economic benefits to be reaped.

Moreover, recommending a replacement purchase once a predetermined amount of time elapses in consideration of durability of clothing enables a situation where the clothing becomes unwearable to the user to be reliably avoided and enables continuous use in a comfortable manner. On the other hand, from the perspective of a provider of a made-to-order service, an effect of avoiding a potential loss of an opportunity to procure an order can be expected.

The embodiment described above can be implemented in various other forms, and various omissions, replacements, and modifications can be made without departing from the gist of the invention. It is to be understood that such embodiments and modifications thereof are included in the scope and gist of the invention and are also included in the invention as set forth in the claims as well as equivalents thereof.

In addition, as a program (software means) that can be executed by a computer, the method described in the embodiment presented above can be stored in a storage medium such as magnetic disk (a flexible disk, a hard disk, or the like), an optical disc (a CD-ROM, a DVD, an MO, or the like), or a semiconductor memory (a ROM, a RAM, a flash memory, or the like) or distributed by being transmitted from a communication medium. The program stored in the medium includes a configuration program that constructs, inside a computer, software means (also including tables and data structures in addition to an executable program) to be executed by the computer.

The computer that realizes the present server reads the program stored in the storage medium and, in some cases, constructs the software means using the configuration program, and executes the processing described earlier by having the software means control operations. It should be noted that the term “storage medium” as used in the present specification is not limited to those intended to be distributed and also includes storage media such as a magnetic disk and a semiconductor memory provided inside the computer or provided in a device being connected via a network.

What is claimed is:

1. A purchase support server, comprising:
circuitry configured to
store attribute information of each user and made-to-order contents of clothing;
specify another user associated with an attribute of a user to purchase made-to-order clothing based on the attribute information of each user and which outputs, to a terminal of the user to purchase made-to-order clothing, information on made-to-order contents of the other user as a custom-making target of the clothing; and
accept a custom-making operation with respect to the output made-to-order contents from the terminal and which executes order processing of the clothing using a made-to-order result obtained by reflecting the custom-making operation onto the made-to-order contents.

2. The purchase support server according to claim 1, wherein the circuitry is further configured to
store character information, and
specify, when specifying the other user, another user with which the character information is associated that is same as or similar to, within a predetermined threshold, the character information selected by the user to purchase made-to-order clothing.

3. The purchase support server according to claim 1, wherein the circuitry is further configured to
output, to the terminal, a presence or absence or the number of other users having purchased made-to-order clothing that is the same as or similar to, within a predetermined threshold, the made-to-order result.

4. The purchase support server according to claim 1, wherein the circuitry is further configured to
output, to the terminal, a presence or absence or the number of at least any of other users within a predetermined range of a location of the user to purchase made-to-order clothing and other users of which a time of purchase of the same or similar made-to-order clothing is within a predetermined period from the present time point among other users having purchased made-to-order clothing that is the same as or similar to the made-to-order result.

5. The purchase support server according to claim 1, wherein the circuitry is further configured to
output information on the made-to-order contents to each of the terminal of the user and a terminal of a designated user having been designated by the user when outputting the information on the made-to-order contents as the custom-making target, and
accept the custom-making operation from each of the terminals of the user and the designated user and execute order processing of the clothing using a made-to-order result obtained by reflecting the custom-making operation accepted from each of the terminals onto the made-to-order contents.

6. The purchase support server according to claim 5, wherein the circuitry is further configured to
disclose the made-to-order result on a predetermined network, accept and aggregates expressed opinions with respect to the disclosed made-to-order result, and disclose a result of the aggregate on the network.

7. The purchase support server according to claim 6, wherein the circuitry is further configured to
specify, when disclosing the result of the aggregate, a popularity order among made-to-order results in accordance with a scale of at least any of likes/dislikes, recommends, and follows with respect to made-to-order results that represent the result of the aggregate and discloses made-to-order results of a predetermined popularity order or higher among the made-to-order results as popular designs on the network.

8. The purchase support server according to claim 6, wherein the circuitry is further configured to
execute processing for giving a predetermined incentive to the user having performed the custom-making operation that is a source of a made-to-order result disclosed on the network in accordance with any event of a like/dislike, a recommend, a follow, and a share with respect to the disclosed made-to-order result.

9. The purchase support server according to claim 1, wherein the circuitry is further configured to
issue, based on durability of material used in the clothing as indicated by the made-to-order result, a notification to the terminal of the user of a replacement purchase time of the clothing.

10. A purchase support method, comprising:
specifying, by a server, another user associated with an attribute of a user to purchase made-to-order clothing based on attribute information stored for each user and outputting, to a terminal of the user to purchase made-to-order clothing, information on made-to-order contents of the other user as a custom-making target of the clothing; and
accepting a custom-making operation with respect to the output made-to-order contents from the terminal and executing order processing of the clothing using a made-to-order result obtained by reflecting the custom-making operation onto the made-to-order contents.

11. The purchase support method of claim 10, further comprising:
storing character information, and
specifying, when specifying the other user, another user with which the character information is associated that is same as or similar to, within a predetermined threshold, the character information selected by the user to purchase made-to-order clothing.

12. The purchase support method of claim 10, further comprising:
outputting, to the terminal, a presence or absence or the number of other users having purchased made-to-order clothing that is the same as or similar to, within a predetermined threshold, the made-to-order result.

13. The purchase support method of claim 10, further comprising:
outputting, to the terminal, a presence or absence or the number of at least any of other users within a predetermined range of a location of the user to purchase made-to-order clothing and other users of which a time of purchase of the same or similar made-to-order clothing is within a predetermined period from the present time point among other users having purchased made-to-order clothing that is the same as or similar to the made-to-order result.

14. The purchase support method of claim 10, further comprising:
outputting information on the made-to-order contents to each of the terminal of the user and a terminal of a designated user having been designated by the user when outputting the information on the made-to-order contents as the custom-making target, and
accepting the custom-making operation from each of the terminals of the user and the designated user and execute order processing of the clothing using a made-to-order result obtained by reflecting the custom-making operation accepted from each of the terminals onto the made-to-order contents.

15. The purchase support method of claim 14, further comprising:
disclosing the made-to-order result on a predetermined network, accepting and aggregating expressed opinions with respect to the disclosed made-to-order result, and disclosing a result of the aggregate on the network.

16. The purchase support method of claim 15, further comprising:
specifying, when disclosing the result of the aggregate, a popularity order among made-to-order results in accordance with a scale of at least any of likes/dislikes, recommends, and follows with respect to made-to-order results that represent the result of the aggregate and discloses made-to-order results of a predetermined popularity order or higher among the made-to-order results as popular designs on the network.

17. The purchase support method of claim 15, further comprising:
executing processing for giving a predetermined incentive to the user having performed the custom-making operation that is a source of a made-to-order result disclosed on the network in accordance with any event of a like/dislike, a recommend, a follow, and a share with respect to the disclosed made-to-order result.

18. The purchase support method of claim 10, further comprising:
issue, based on durability of material used in the clothing as indicated by the made-to-order result, a notification to the terminal of the user of a replacement purchase time of the clothing.

19. A purchase support system, comprising:
a purchase support server, the purchase support server including circuitry configured to
store attribute information of each user and made-to-order contents of clothing;
specify another user associated with an attribute of a user to purchase made-to-order clothing based on the attribute information of each user and which outputs, to a terminal of the user to purchase made-to-order clothing, information on made-to-order contents of the other user as a custom-making target of the clothing; and
accept a custom-making operation with respect to the output made-to-order contents from the terminal and which executes order processing of the clothing using a made-to-order result obtained by reflecting the custom-making operation onto the made-to-order contents; and
a terminal, the terminal including circuitry configured to
transmit a made-to-order request including the attribute information of the user to the purchase support server and which acquires and displays information on the custom-making target; and
accept a custom-making operation by the user with respect to the displayed information on the custom-making target and which transmits contents of the custom-making operation as the made-to-order result to the purchase support server.

20. A non-transitory computer-readable storage medium storing computer-readable instructions thereon which, when executed by a computer, cause the computer to perform a method, the method comprising:
specifying another user associated with an attribute of a user to purchase made-to-order clothing based on attribute information store for each user and outputting, to a terminal of the user to purchase made-to-order clothing, information on made-to-order contents of the other user as a custom-making target of the clothing; and
accepting a custom-making operation with respect to the output made-to-order contents from the terminal and executing order processing of the clothing using a made-to-order result obtained by reflecting the custom-making operation onto the made-to-order contents.
